(19) United States
(12) Patent Application Publication
(10) Pub. No.: US 2025/0222341 A1
(43) Pub. Date: Jul. 10, 2025

(54) A COUPLING ARRANGEMENT FOR A DETACHABLE GROUND DEPOSITION ACCESSORY

(71) Applicant: Micropply Limited, Altrincham, Cheshire (GB)

(72) Inventors: Anthony David George Rhoades, Hale, Altrincham (GB); Samuel Paul Cornish-Evans, Knutsford, Cheshire (GB); Lewis Cassidy, Stretford, Manchester (GB)

(21) Appl. No.: 18/853,280

(22) PCT Filed: Apr. 6, 2023
(86) PCT No.: PCT/GB2023/050928

§ 371 Date: Oct. 1, 2024

(30) Foreign Application Priority Data
Apr. 6, 2022 (GB) 2205018.1
Apr. 12, 2022 (GB) 2205452.2
May 31, 2022 (GB) 2208009.7
May 31, 2022 (GB) 2208013.9
Sep. 7, 2022 (GB) 2213059.5
Oct. 3, 2022 (GB) 2214496.8
Oct. 10, 2022 (GB) 2214910.8
Oct. 25, 2022 (GB) 2215768.9

(51) Int. Cl. A63C 19/06; B25J 5/00; B25J 15/04

(52) U.S. Cl. CPC A63C 19/065; B25J 5/007; B25J 15/0416; A63C 2019/067; A63C 2203/24

(57) ABSTRACT

A coupling arrangement for a coupling a detachable deposition accessory to an autonomous mobile robot (AMR), the coupling arrangement comprising: a first portion, the first portion is configured to be removably coupled to the AMR, and is operable to be pivotable about the pitch axis only; a second portion, the second portion is fixedly attached to the AMR and is configured to retain the first portion and limit movement of the detachable deposition accessory in the yaw axis, when coupled to the AMR; and a support arm, wherein the support arm extends between the first and second portions. Thus advantageously, there is provided the means to quickly and easily change the abilities of the autonomous deposition machine attached to an AMR for multiple different deposition application situations.

The present invention relates to a coupling attachment for a detachable, deposition accessory for attaching it to an Autonomous Mobile Robot (AMR), the deposition accessory comprising a quick remove/replace deposition material cartridge design and quick connect mounting for said cartridge. The detachable, deposition accessory specifically equipped to deposit materials such as ink and paint, but may equally deposit sand, seed, fertiliser, or other ground treatments onto a ground surface or for injection under pressure into a ground surface.

### BACKGROUND

Ground marking has traditionally been carried out using manual processes. Ground marking may be carried out using manual line marking equipment, for example to mark out sports pitches, or by using a manual image painting process using stencils and paint which may be painted or sprayed into the cut-outs in the stencils, for example to mark areas of ground with a sponsor logo. Such logos may be required to be large enough to see from a long distance, in some cases by aerial photography of all or parts of a sports pitch or venue, and such manual marking can therefore take considerable time to complete, especially if the image to be painted is complex or is a multi-colour image. Further, such a manual process can be a complex task requiring significant user skill to complete. In addition, manual painting of a ground surface can often only provide satisfactory visible results when the ground surface Is saturated in paint, such that the intensity of an image is consistent at different parts of the image. Such saturation of the ground surface with paint firstly consumes considerable paint at considerable cost, secondly causes difficulty in removing the paint once the image is no longer required to be present on the ground surface, and thirdly has a more detrimental effect on the environment.

Autonomous ground printers, also known as autonomous ground marking machines, are becoming more commonplace for line marking of sports pitches and for image printing of logos. Such ground printers can autonomously move on a predetermined path and deposit paint in a predetermined pattern to mark lines or print pixels on a ground surface. In particular, paint or ink can be deposited by a single print nozzle to form a line or a pixel of an image, or from multiple print nozzles to form multiple pixels of an image. However, such printing can still be slow when an image requires multiple colours of paint or ink to be deposited, and the image intensity can vary dependent on the ground surface.

One approach to automating ground marking is found in US 2005/0055142 A1 in which a turf marker comprises a ground maintenance vehicle adapted to both mow and store grass as well as carry a marking device that includes a delivery system for applying a marking material to the ground. Dispensing devices for putting down marking materials are provided in the form of boxes requiring mechanisms that require to be driven such as a motor, electric, air or another fluid motor.

One approach to scalable autonomous ground marking is found in the Applicant's co-pending patent “Ground Printing Machine”, Micropply Limited, PCT/GB2021/052671, which discloses an ADR machine capable of ground printing and which uses the tiling of segments to cover a large image print area.

Another approach is found in Pixelrunner's application US2019381529, which discloses using a single fixed sprayer arm with numerous nozzle assemblies arranged next to one another.

Autonomous Mobile Robots (AMRs) may be completely autonomous (i.e. free from human operation and/or supervision) or may require at least partial human operation and/or supervision depending on the application.

### SUMMARY OF INVENTION

Aspects and embodiments of the invention provide a detachable deposition accessory for marking a ground surface, via the use of an attached AMR, and a method of marking a ground surface, as claimed in the appended claims.

In a first aspect of the present invention, there is provided a coupling arrangement for a coupling a detachable deposition accessory to an autonomous mobile robot (AMR), the coupling arrangement comprising: a first portion, the first portion is configured to be removably coupled to the AMR, and is operable to be pivotable about the pitch axis only; a second portion, the second portion is fixedly attached to the AMR and is configured to retain the first portion and limit movement of the detachable deposition accessory in the yaw axis, when coupled to the AMR; and a support arm, wherein the support arm extends between the first and second portions.

Preferably, wherein movement in the yaw axis is limited to less than a 5-degree angle between the first and second portions.

Also preferably, wherein either the first and/or second portions are comprised of metal plates.

Further preferably, wherein the first and second portions are operable to be magnetised by an applied current.

Preferably, wherein the second portion further comprises a mechanical clamp arrangement, and wherein the mechanical clamp arrangement is configured to retain the first portion and limit movement of the autonomous deposition accessory in the yaw axis, when coupled to the detachable deposition accessory.

Also preferably, wherein the second portion further comprises a retaining seat, operable to retain the first portion in a planar alignment with the second portion.

Further preferably, wherein the support arm maybe pivotable about a second single pivot axis, also limited in the yaw axis.

Preferably, wherein the support arm may be formed of metal.

Also preferably, wherein either of the first or second portions further comprise movement stoppers, operable to limit the movement of the either of the first or second portions in the pitch axis.

Further preferably, wherein the coupling further comprises a data connection, wherein the data connection is operable to send data between the detachable deposition accessory and the AMR.

Preferably, wherein the coupling further comprises a power connection, wherein the power connection is operable to send electrical power between the detachable deposition accessory and the autonomous deposition apparatus.

In a second aspect of the present invention, there is provided a detachable deposition accessory for coupling to an autonomous mobile robot (AMR), the detachable deposition accessory comprising: a locomotion arrangement; a deposition arrangement; at least one receptacle to hold a deposition material; a control unit, the control unit operable to receive at least one deposition instruction from the AMR; and a coupling arrangement according to the first aspect.

Preferably, wherein the control unit operable to send data from the detachable deposition accessory to the AMR.

Further preferably, wherein the detachable deposition accessory further comprises a chassis with a nozzle array on a traverse guide.

In a third aspect of the present invention, there is provided autonomous mobile robot (AMR), the AMR comprising: a locomotion arrangement; a control unit, the control unit operable to receive at least one deposition instruction; and a coupling arrangement capable of attaching to a detachable deposition accessory according to any of the first or second aspects.

In a fourth aspect of the present invention, there is provided method of coupling a detachable deposition accessory to an autonomous mobile robot (AMR) of any of the preceding aspects, the method comprising: moving the detachable deposition accessory and the AMR into close proximity; locating a first portion of the coupling arrangement attached to the detachable deposition accessory into a housing seat located on the AMR; and switching on the electromagnet system.

Preferably, the method further comprises the step of coupling a data and/or power cable between the detachable deposition accessory and the AMR.

Also preferably, the method further comprises the step of attaching a break chain between the detachable deposition accessory and the AMR.

Further preferably, wherein the moving step further comprises using position sensors located on either of the detachable deposition accessory or the AMR.

In a fifth aspect of the present invention, there is provided method of depositing a material using the apparatus of any of the previous aspects, the method comprising: an operator coupling a detachable deposition accessory of any of the preceding aspects to an AMR; receiving at least one deposition instruction from a user; the AMR controlling the detachable deposition accessory to deposit material according to the deposition instructions.

Preferably, wherein after it is coupled to the AMR, the detachable deposition accessory sends data to the AMR.

Also preferably, wherein the user sends deposition instructions to the AMR via a cloud server or device, or an edge server or device.

Further and in relation to any and all preceding aspects, preferably wherein the material for deposition is a herbicide, pesticide, insecticide, plant growth aid, water or marking material, optionally wherein the marking material is a paint, ink, coloured material, powder.

Thus advantageously, there is provided the means to quickly and easily change the abilities of the autonomous deposition machine attached to an AMR for multiple different deposition application situations.

Thus, there is provided an improved high-resolution grand-scale accuracy of ground printing and deposition systems. Furthermore, delivering navigational accuracy for a ground marking system ensuring flexibility, scalability, ease-of-use, and robustness for the ground marking systems. With these elements in place, machines such as the one disclosed in this application can fully satisfy even the most extreme scale market demands such as ‘full pitch’ print activations used in the NFL (National Football League).

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE FIGURES

Embodiments of the invention will now be described by way of example only and with reference to the accompanying drawings, in which:

FIG. 1 is a plan view of a detachable deposition accessory, according to one embodiment of the present invention;

FIGS. 2a & 2b are schematic diagrams illustrating a side and plan view of the detachable deposition accessory of FIG. 1 coupled to an autonomous mobile robot (AMR);

FIG. 3 is an illustration of the detachable deposition accessory of FIGS. 1 & 2, without its cover;

FIG. 4 illustrates a perspective view of a carriage for a print rack arrangement used in the detachable deposition accessory of the previous Figures, according to an embodiment of the invention;

FIGS. 5a, 5b & 5c Illustrate in more detail, three different views of the print head arrangement of FIG. 4;

FIG. 6 is a side view illustrating a detachable deposition accessory with an externally mounted removable paint cartridge, according to an embodiment of the invention;

FIG. 7 is a perspective view of a quick-connect cartridge mount used to couple the detachable deposition accessory of FIG. 6 with an externally mounted removable paint cartridge;

FIG. 8 illustrates a side view of an externally mounted removable paint cartridge and associated spray arrangement for the ground printer of FIG. 6;

FIGS. 9a, 9b, 9c, 9d & 9e are different views of the individual components of the coupling used between an AMR and the detachable deposition accessory of FIGS. 1 to 8; and

FIG. 10 is a flow diagram of the method of marking a ground surface according to an embodiment of the invention.

The present techniques will be described more fully hereinafter with reference to the accompanying drawings. Like numbers refer to like elements throughout. Parts of the detachable ground deposition accessory are not necessarily to scale and may just be representative of components of the ground print machines, or other described entities.

Examples of the present disclosure relate to an apparatus for marking a ground surface. In particular, examples of the present disclosure relate to an apparatus for marking a ground surface having spray nozzles for ejecting paint or ink, under pressure, onto a ground surface. Non-limiting examples will now be described with reference to the accompanying drawings.

### DETAILED DESCRIPTION

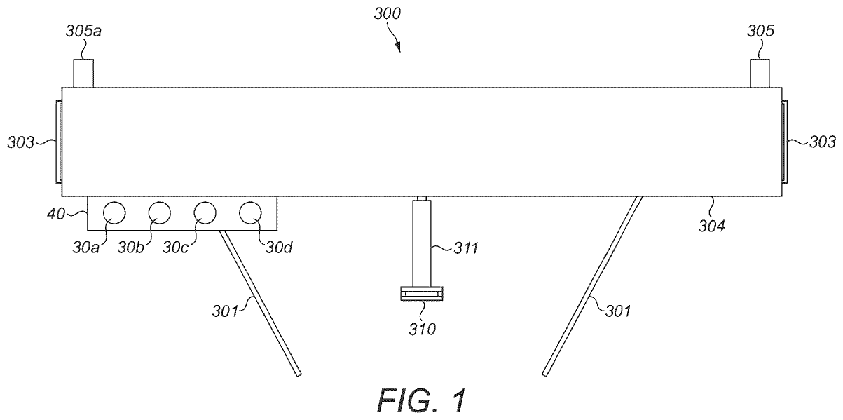

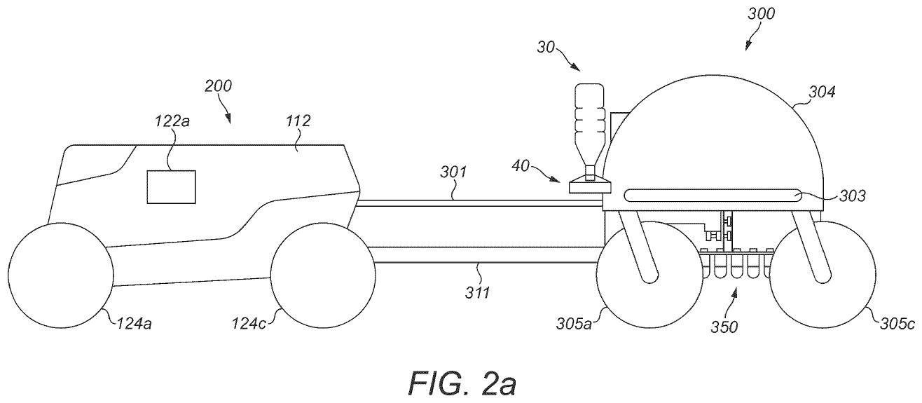

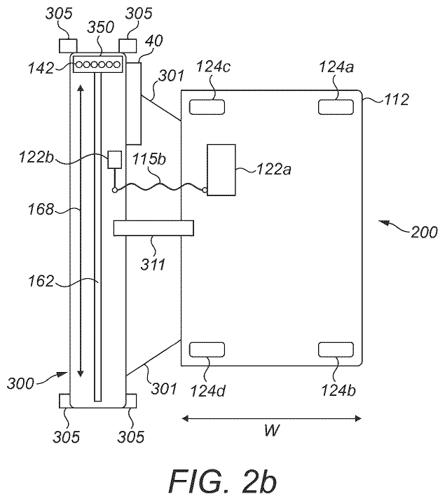

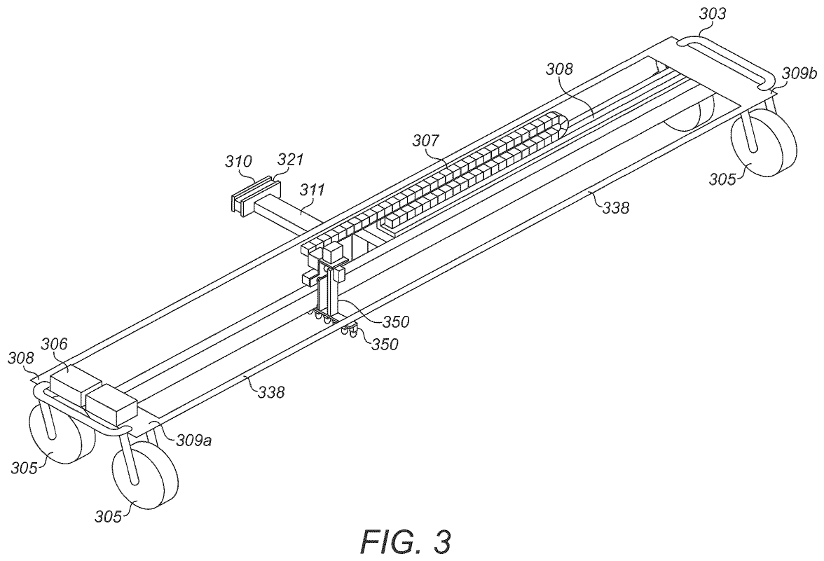

FIG. 1 is a plan view illustration of a detachable deposition accessory according to one embodiment of the present invention. There is shown a detachable deposition accessory 300, comprising a case 304 held securely by a chassis (see FIG. 3) supporting a ground wheel arrangement, comprising a set of wheels 305a, b, c, d, (although only wheels 305a & c are shown) to allow the detachable deposition accessory 300 to be steered along a path by an AMR, as shall be further described with reference to FIG. 2 following.

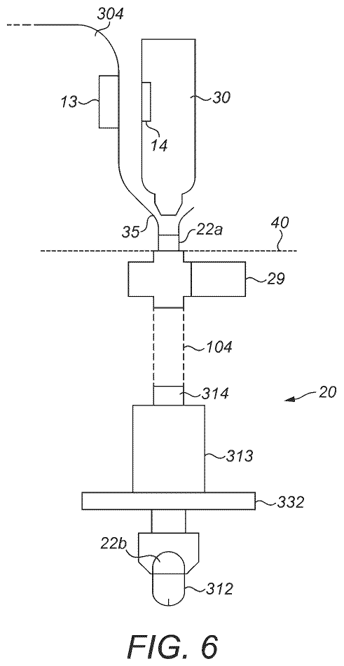

As illustrated best in FIG. 6, the paint, or material to be deposited, is retained onboard the detachable deposition accessory 300 in a series of removable cartridges 30(a, b, c, d), which are inserted into quick-connect cartridge mounts (see FIG. 6) mounted on a mounting plate 40, located externally to the casing 304 of the detachable deposition accessory 300.

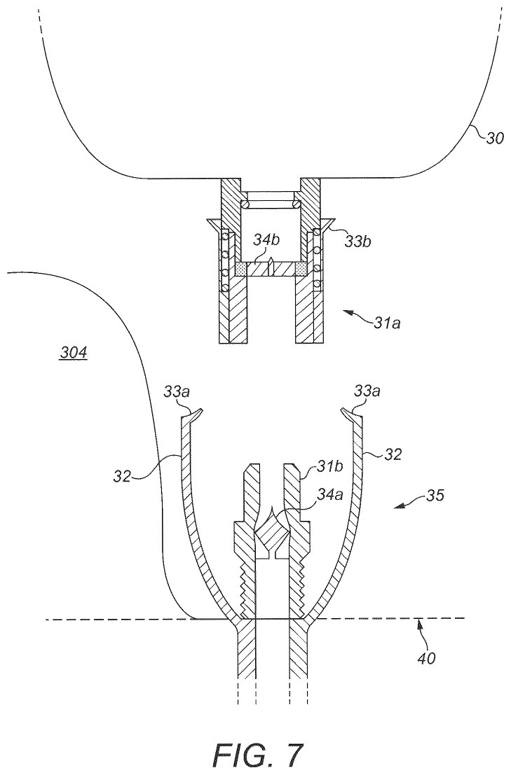

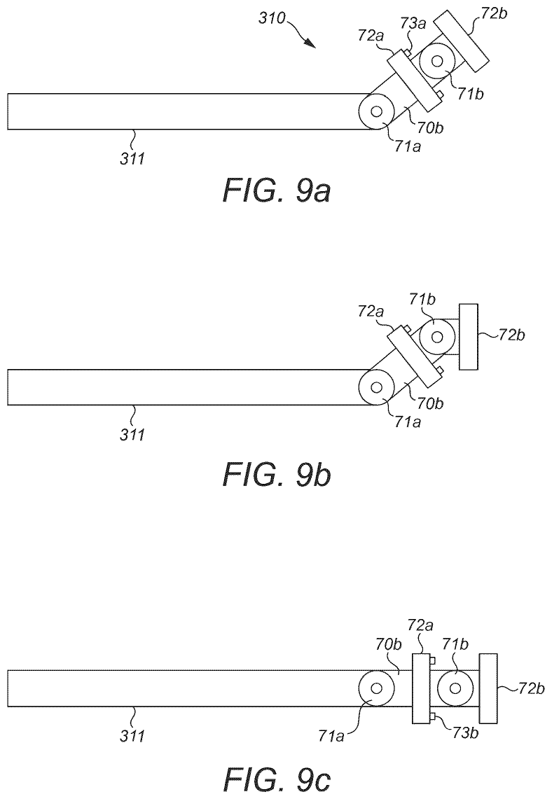

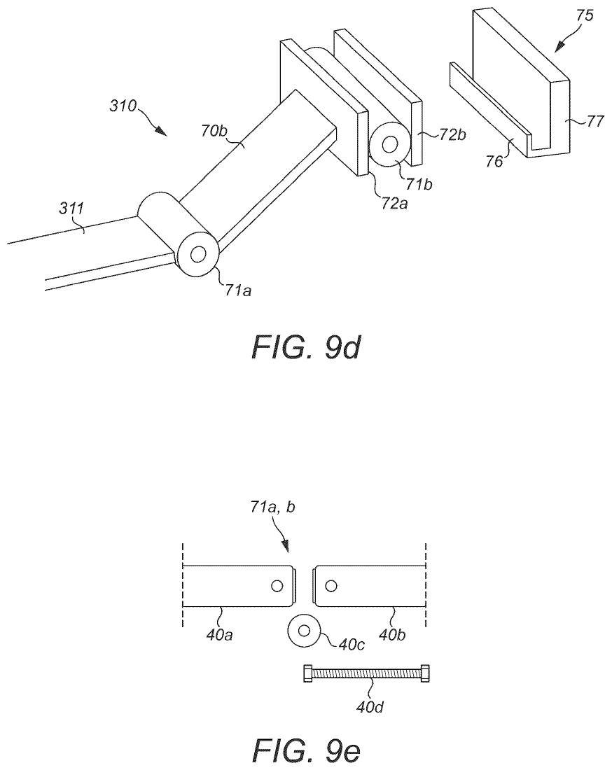

As will also be described in relation to FIGS. 3 & 6, the paint, or deposition material, may be ejected from a plurality of spray nozzles (see FIG. 3) under pressure to form small droplets of paint to uniformly cover a ground surface. Each of the removable paint cartridges 30(a, b, c) forms part of a pressurised airless spray system 20 (see FIG. 7). Whilst only four removable paint cartridges 30(a, b, c, d) are shown for ease, as many removable paint cartridges 30(a, b, c) as there are spray nozzles can be mounted via the quick-connect cartridge mounts on the mounting plate 40, as shall be described with further detail in FIG. 6 & 7.

Wherein the detachable deposition accessory 300 can be connected, or coupled, to an autonomous mobile robot (AMR) (see FIG. 2) via a tow arm 311 and set of stabilising arms 301. The tow arm 311 further comprises a magnetic connection coupling 310. The magnetic connection coupling 310 is further described with reference to FIG. 9 and is powerful enough and strong enough to keep the detachable deposition accessory 300 attached securely enough to minimise any lateral or vibrational movement between the detachable deposition accessory 300 and the AMR (see FIG. 2). The two stabilising arms 301, also contribute to the minimisation of any lateral or vibrational movement between the detachable deposition accessory 300 and the AMR (see FIG. 2) to which is attached. These two stabilising arms 301 can also be applied to the detachable deposition accessory of FIGS. 1 to 3, or left off completely, depending upon the size and application of the detachable deposition accessory 300.

Also connecting the detachable deposition accessory 300 to the AMR (of FIG. 2) is an umbilical (not shown). Wherein the umbilical further comprises a serial data cable and a 10-amp power cable and is connected to the AMR (of FIG. 2), as is further described with reference to FIG. 9.

FIG. 2a is a side view and FIG. 2b is a plan view of the detachable print head accessory of FIG. 1, coupled to an autonomous mobile robot (AMR). In both FIGS. 2a and 2b, there is shown an autonomous mobile robot (AMR) 200, comprising a case 112 held securely by a chassis supporting the ground wheel arrangement 124.

Wherein the detachable deposition accessory 300 is connected, or coupled, to the chassis of the AMR 200 by a magnetic connection 311. The magnetic connection 311 taking the form of an angled metal bracket surrounding a metal contact point, which completes an electrical connection between AMR 200 and the detachable deposition accessory 300 and is further described with reference to FIG. 9.

As previously explained with reference to FIG. 1, the paint, or material to be deposited is retained onboard the detachable deposition accessory 300 in a series of removable cartridges 30(a, b, c, d), which are inserted into quick-connect cartridge mounts 35 (see FIGS. 6 & 7) mounted on a mounting plate 40, located externally to the casing 304 of the detachable deposition accessory 300.

As best shown in FIG. 2b, the ground wheel arrangement 124 further comprises wheels 124a, 124b, 124c and 124d to steer the AMR 200 along a path to affect the printing, and this may be under the control of a print file that can be loaded into the onboard control system, such as may be contained in a system control and communications module 122a, as further described herein and with reference to the Applicants' co-pending applications.

There is also shown the detachable deposition accessory 300 of FIG. 1, which comprises a traverse guide 162, a print head arrangement 350 and nozzle array 142. The traverse guide 162 permits movement of the print head arrangement 350 along the length of a print width 168,

Also connecting the detachable deposition accessory 300 to the AMR 200 is an umbilical 115b, wherein the umbilical 115b further comprises a serial data cable and a 10-amp power cable. The umbilical 115b is connected to the AMR 200 via a male/female socket which is mounted on a mounting plate on the underside of the AMR 200 (not shown) and is further described with reference to FIG. 9.

The serial data cable is connected to a sub-controller 122b, which further comprises an application processor (not shown), which comprises software code about the detachable deposition accessory 300. The software code comprising key usage variables and information about the detachable deposition accessory 300, which when the umbilical 115b is connected, the information is uploaded to the AMR 200 such that the AMR 200 can operate the detachable deposition accessory 300. Thus, the detachable deposition accessory 300 has independent processing capability and can carry out tasks that the ‘parent’ AMR 200 gives it.

Once the detachable deposition accessory 300 is coupled to the AMR 200, the software loaded on the application processor of the sub-controller 122b may also carry out such activities as to check the detachable deposition accessory 300 is authorised and/or is compatible to be used with the AMR 200.

Via the serial data connection (not shown), the AMR 200 may also gather performance diagnostics of the detachable deposition accessory 300, such as faults, errors messages and or consumption of materials.

In the present example, each AMR 200 is configured to connect with a cloud network and/or or an edge device to push data thereto, as well as receive data. In the present example, it will be appreciated that the cloud may comprise any suitable data processing device or embedded system which can be accessed from another platform such as a remote computer, content aggregator or cloud platform which receives data posted by the AMR 200. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some examples, processing circuitry may be distributed across multiple separate processors or processing units, for example, multiple of the same type of processing units (e.g. two Intel Core i7 processors) or multiple different processors (e.g., an Intel Core i5 processor and an Intel Core i7 processor). In some examples, or the system controller 122a or cloud executes instructions for each AMR 200.

It will be appreciated that the autonomous mobile robot 200 may connect to the cloud or the edge, e.g. via the internet, using one or more nodes/routers in a network e.g. a mesh network. The connection may be one or more networks including the Internet, a mobile phone network, mobile voice or data network (e.g., a 3G, 4G, 5G or LTE network), mesh network, peer-to-peer network, cable network, cable reception (e.g., coaxial), microwave link, DSL reception, cable internet reception, fibre reception, over-the-air infrastructure or other types of communications network or combinations of communications networks. The AMR 200 may be coupled to a secondary communication network (e.g., Bluetooth, Near Field

Communication, service provider proprietary networks, or wired connection) to push data thereto, as well as receive data. Paths may separately or together include one or more communications paths, such as a satellite path, a fibre-optic path, a cable path, a path that supports Internet communications, free-space connections (e.g., for broadcast or other wireless signals), or any other suitable wired or wireless communications path or combination of such paths.

As illustrated in FIG. 3, there is illustrated the detachable deposition accessory of FIGS. 1 & 2, without its cover, comprising a chassis 338 supporting a ground wheel arrangement (wheels 305) to enable the detachable deposition accessory 300 to be steered along a path to affect the printing. Wherein the detachable deposition accessory 300 can be connected, or coupled, to an AMR (see FIG. 2) via a tow arm 311. The tow arm 311 further comprises a magnetic coupling arrangement 310. A pair of carrying handles 303 is also shown.

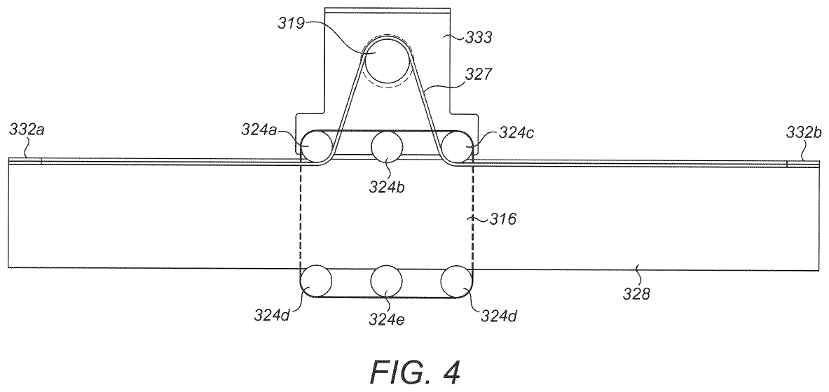

The detachable deposition accessory 300 further comprises a vertically orientated print head arrangement 350 (as described further with reference to FIG. 4), which comprises one or more spray nozzles 312. Wherein the print head arrangement 350 moves along a horizontal rail 328, whilst maintaining its vertical orientation, between a first end stop 309a at a first end of the horizontal rail 328, and a second end stop 309b, at a second end of the horizontal rail 328. The horizontal rail 328 is supported by the chassis 338 and the ground wheel arrangement (wheels 305).

As described, printing from the spray nozzles 312 can be carried out as the vertical print head arrangement 350 moves from a first end of the horizontal rail 328 to a second end of the horizontal rail 328 and can also be carried out as the vertical print head arrangement 350 moves from the second end of the horizontal rail 328 to the first end of the horizontal rail 328, thereby providing multi-directional printing. The spray nozzles 312 are positionally fixed relative to each other such that there is a known separation between each spray nozzle 312.

One, or both, of the first end stop 309a and the second end stop 309b may comprise a sensor 315 to detect the position of the print head arrangement 350. The, or each, sensor 315 may be a switch, such as a limit switch, arranged or configured to act as an end stop and to indicate when the print head arrangement 350 is positioned at an outer extremity of the printing range of the ground printer accessory 300. The sensor 315 or sensors can provide information to the controller 306 indicating the position of the print head arrangement 350, such that the controller 306 can be sure as to the absolute print head arrangement 350 position at that time. The sensor 315 may provide a home signal to the controller 306 to calibrate the position of the print head arrangement 350, such that, at any time during a printing process, the controller 306 may control the print head arrangement 350 to move to the end stop 309a, b to activate the sensor 315 and reset position Information retained for the print head arrangement 350 held by the controller 306. In this way, the accuracy of printing can be maintained over a whole print task.

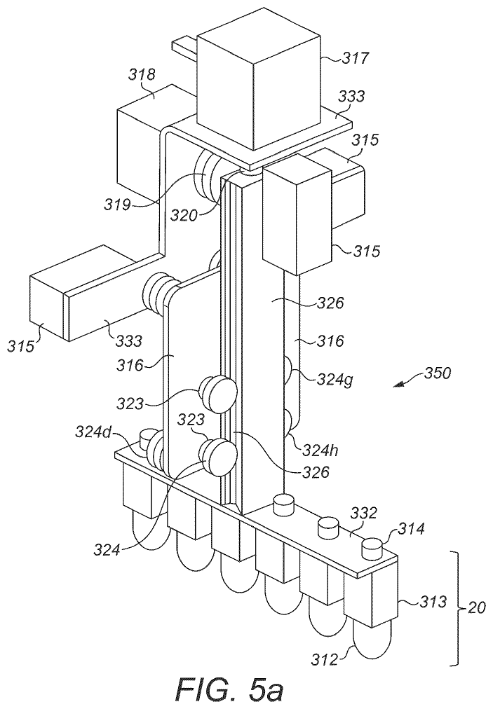

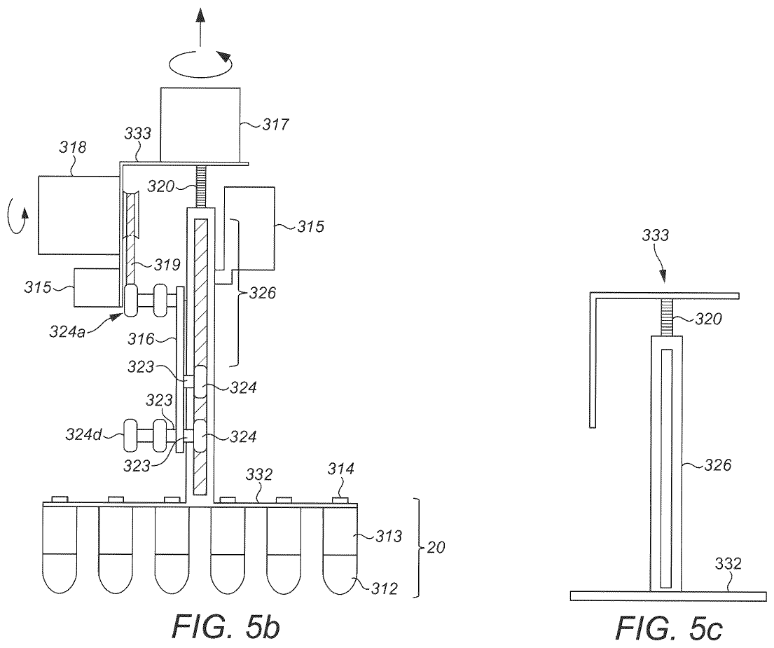

The print head arrangement 350 many also be movable vertically based on the image to be printed, for example the print head arrangement 350 can be moved up and down depending on the density of the Image to be printed, as shall be described with reference to FIG. 5 following. The print head arrangement 350 can have a means, such as a sensor, (not shown) to monitor the ground height and adjust the height of the print head arrangement 350 accordingly above a ground surface, allowing for more accurate image printing or material deposition. For example, the vertically arranged print head arrangement 350 may be raised when printing on grass or when printing an image which is to have a lower resolution, that is a larger pixel size, and the vertically arranged print head arrangement 350 may be lowered when printing on asphalt or when printing an image which is to have a higher resolution, that is a smaller pixel size.

In some embodiments flexible tubing (see FIG. 6) is used to transfer or convey paint from a paint cartridge (see FIG. 6) to a spray nozzle 312 and may have a small inner diameter, for example, 2.5 mm diameter, with a relatively thin sidewall. Such a flexible tubing size allows substantially unimpeded movement of the spray nozzles 312 in all required directions, such that there is less torque required by the stepper motors (see FIG. 5) to move the spray nozzles 312. Various materials may be used to form the flexible tubing where some materials may be one of polyurethane, polyvinyl chloride, polypropylene, fluoropolymer, rubber, silicone or other similar materials.

The flexible tubing may be retained using a first cable chain, echain, or cable carrier 307, and is located in a cable trough 308, cooperatively functioning as a tubing carrier 307, 308, mounted to the vertical print head arrangement 350. The flexible tubing passes or is routed from a respective spray nozzle 312, through the tubing carrier 307, 308, to the respective paint reservoir (not shown). By routing the flexible tubing through the tubing carrier 307, 308, the tubing is less prone to becoming entangled or caught on any other component of the ground printer accessory 300 during the movement of the spray nozzles 312 horizontally.

A separate controller 306 is provided, which amongst controlling other localised actions, may be configured to control a valve (see FIG. 6), such as a solenoid valve, for each of the plurality of spray nozzles 312, dependent upon the position of the ground printer accessory 300 on the ground surface. The controller 306 also controls the position of the movement of the print head arrangement 350 along the horizontal rail 328 under instruction from the AMR (of FIG. 2).

It should be clear to someone skilled in the art that the specific arrangement of the print head arrangement 350, horizontal rail 338 and tubing carrier 307, 308 provides advantage over the systems and methods known art, as it can be adjusted to fit any width deposition apparatus by the simple adjustment of the length of the horizontal rail 328 and tubing carrier 307, 308. The respective motor sizes and flexible tubing lengths also need to be adjusted accordingly.

FIG. 4 illustrates the carriage and tension belt arrangement used within the print head arrangement of FIG. 3. The second mounting plate 333 is also coupled to a carriage system 316, wherein the carriage system 316 further comprises 10 linear guide wheels 324(a to j). Wherein a first set of 6 wheels (a to f) allow the carriage 316 to move up and down the horizontal rail 328 (see FIG. 3) and a second set of 4 (not shown in FIG. 3) allow the carriage 316 to move up and down the linear rail 326, as shown in FIGS. 5a and 5c.

Wherein three of the linear guide wheels 324(d, e, f) on the lower portion of the carriage 316 are provided with eccentric nuts 323 (see FIG. 9). These are used to clamp the three linear guide wheels 324 onto the track portion of the horizontal rail 328 (see FIG. 4); and wherein the four wheels (g to j) on the front side of the carriage 316 are provided with eccentric nuts 323 to clamps to the linear rail 326 (see FIGS. 4 & 5).

The three wheels 324(a, b, c) on the upper portion of the carriage 316 are not provided with eccentric nuts 323, as gravity enables this portion of the carriage 316 to retain place and indeed, the application of torque on any such eccentric nuts 323(a, b, c) may off balance the carriage 316 and potentially twist the carriage 316 as it moves along the horizontal rail 338.

There is also shown an x-axis motor 318 (as also shown in FIGS. 3, 4 & 5), which drives an x-axis pulley 319, which in turn drives a tension belt 327. The tension belt 327, is held in place by two of the 6 linear guide wheels 324(a, c) and is fixed in place at each end of the horizontal rail 328 (shown in shade) by fixings 332a, 332b. The central wheels (b, e) are there to provide extra load sharing between carriage 316 and the horizontal rail 328.

The tension, and thus stability of the position of the carriage 316 whilst it is moving up along the horizontal rail 328 is maintained using a tension belt 327 arrangement shown in FIG. 4.

FIGS. 5a, 5b & 5c illustrate, in more detail, three different views of the print head arrangement of FIG. 3. Turning to Figure Sc first, there is shown, a section of v-slot extrusion, which forms a linear rail 326. To the bottom end of one end of the linear rail 326, there is a first mounting plate 331 to which a nozzle array 312 is fixed (as shall be further described with reference to FIGS. 5a, 5b, & 6). At the opposed end of the linear rail 326 is a second mounting plate 333, which is affixed by a lead screw 320. The second mounting plate 333 being formed of two sections arranged at right angles to each other and to which is further affixed two motors (317, 318), as well as a carriage 316, as shall be further described with reference to FIGS. 5a & 5b.

As can be seen best in FIG. 5b, and as has been previously described, to the bottom end of one end of the linear rail 326, there is affixed a first mounting plate 331. Further affixed to the first mounting plate 331 is a plurality of solenoids 313 and push-fit hose attachments 314.

As further described with reference to FIGS. 6 & 7, the paint is retained onboard the ground printer in a series of paint cartridges, or reservoirs, Wherein each spray nozzle 312 of the plurality of spray nozzles may be coupled to a separate respective paint cartridge, via flexible tubing, or hoses (not shown) coupled to the hose attachments (314). Each spray nozzle 312 may be coupled to a separate respective paint cartridge via the flexible tubing (see FIGS. 6 & 7) and a solenoid valve 313. Wherein each solenoid valve 313 is controlled by an onboard controller 306, to be open when printing of a ground surface is required and closed when printing is not required. Each spray nozzle 312, valve 313 and hose attachment 314 forming a spray system 20, as shall be described with further detail with reference to FIG. 6 following.

A pump, such as a self-priming diaphragm pump (see FIG. 6), may be used to pressurise the hoses for each respective spray nozzle 312. The pumps may be individually controlled by the controller 306 and the pressure for each pump may be adjusted depending on the paint being used for the respective spray nozzle 312.

In some arrangements, each solenoid valve 313 may be located nearer to the paint reservoir and may be separated from its corresponding nozzle 312 by the length of flexible tubing or hose. In the arrangement shown in FIGS. 5a & 5b, It is shown that the solenoids 313 are arranged next their respective nozzles 312, which means reduction in pipe length between solenoids and print nozzles, mean reduced head of pressure. This arrangement beneficially reduces dripping of paint from the spray nozzles 312, by providing back pressure at the spray nozzles 312. Such an arrangement differs from agricultural spray systems, which use less viscous fluids than the present invention and use breather nozzles to help with back pressure, which can lead to dripping of fluids onto a ground surface. However, in agricultural spray systems, dripping of the fluids onto the ground surface is generally not a problem. The higher viscosity fluids, such as paint, used in the present invention do not provide the same back pressure problem, and this coupled with the pressurization of the spray system minimises dripping of paint onto the ground surface.

In another example (not shown), the plurality of print nozzles 312 could be arranged at right angles to the linear rail 326. However, the symmetrical arrangement of the print nozzles around the linear rail 326, as shown in FIG. 5b particularly, provides a better balance to the print head arrangement 350, which leads to an improved accurate print accuracy,

As has been previously described, at the opposed end of the linear rail 326 is a second mounting plate 333, which is affixed by a lead screw 320 to the linear rail and at its other end, an x-axis motor 317. Wherein the x-axis motor 318 turns the lead screw 320, which in turn makes the printhead arrangement 350 move up and down on the vertical v-slot. In other examples, a second pulley system can be used instead of the lead screw 320 in order to supply movement to the printhead arrangement in the z axis. The lead screw 320 arrangement as shown in FIG. 5 has advantages over a second pulley system, for many reasons: it is mechanically sounder, there is less flexibility/variation in movement when in the carriage is in situ, as belts both stretch and vibrate.

As described with reference to FIG. 4 previously, wherein three of the linear guide wheels 324(d, e, f) on the lower portion of carriage 316 are provided with eccentric nuts 323. This is to clamp the three linear guide wheels 324 onto the track portion of the horizontal rail 338 (see FIG. 3); and wherein the four wheels (g to j) on the front side of the carriage 316 are provided with eccentric nuts 323 to clamps to the linear rail 326.

This arrangement of the two wheels 324a, 324c and tension belt 327 arrangement with the centrally placed x-axis motor 319, being particularly suitable for use on surfaces that are sloped. This is because the tension pully slack is maintained across the width of the carriage 316 whilst operating with a print head that is not level with the plane of gravity. Specifically, when x-axis motor 318 is operating to pull the print head up when sloped, will be working harder than when the print head is being moved down the slope. In such cases, the tension belt may have slack and/or tension issues which are compensated for by the balance of the two wheels acting either side of the fixing point of the x-axis motor 319.

FIG. 7 is a perspective diagram of a quick-connect cartridge mount used to couple to an externally mounted removable paint cartridge 30 of the present invention. There is shown a quick connect connector 31 formed of a male and female portion 31a & 31b, wherein the female portion 31a includes a flexible diaphragm 34b and the male portion 31b further includes a breather 34a, which when coupled, forms an airtight connection.

A paint cartridge 30 is guided into place by a connector guide 32, which is mounted on the chassis mount 40 and can be made of plastic or other suitable materials and which is flexible. At an end furthest away from the chassis mount 40, the connector guide 32 may further comprise at least one first cartridge retainer portion 33a which may interlock with a second cartridge retainer portion 33b located on the neck of removable cartridge 30. The first cartridge retainer portion 33a second cartridge retainer portions 33b providing extra stability and security when the paint cartridge is in position on the quick-connect cartridge mount 35.

The quick-connect cartridge mount 35 is mounted on the chassis mount 40, which is formed over, or connected to, the chassis 338 of the detachable deposition accessory 300.

Quick-connect connectors 31 are known in the art and are generally a male 31b and female 31a push fit cartridge mount coupling and can be released without the need for tools. Generally, they are comprised of a plunger on a spring mechanism, and in most paint deposition situations both parts would need to be able to be airtight/fluidly sealed when fitted. They usually comprise a tab or pressure release button or area in operation and in a preferred embodiment, both ends would have a dust cover, or be closed off, when not connected. Especially with the part located on the cartridge 30, as it would need to be turned upside down to insert it, as it would be very important that minimal material can escape when doing so. The advantage of having a protective cover on the receiving part of the quick cartridge mount 35(a, b, c) mounted on the mounting place 40, is that it may be essential no dust or materials can get into the airless spray system (of FIG. 7) when no cartridge 30 is fitted.

As such it should be clear to someone skilled in the art, that the opening area or ‘neck’ of the cartridge 30, must be compatible in design with the opening area or ‘seat’ area of the relevant quick-connect cartridge mount 35(a, b, c). It should also be clear to someone skilled in the art that other connector arrangements, or combination of arrangements, may be suitable, Including screw systems, or clip systems. Depending upon the materials to be deposited and the width of the hosing etc, different quick-connect connector solutions can be chosen.

In FIG. 6, there is shown an airless spray nozzle arrangement 20 is shown, which is operable to convey paint from the paint cartridge 30 to a respective spray nozzle 26,

As described previously in FIG. 7, each paint cartridge 30 is externally mounted to the casing 12 of the detachable deposition accessory 300 by means of a quick-connect cartridge mount mounted on a mounting plate 40.

A valve 313, such as a solenoid valve, is located between the paint cartridge 30 and the spray nozzle 312. The valve 313 is controlled by an onboard controller (not shown), to be open when printing on the ground surface is required and closed when printing is not required. Each spray nozzle 312 may be coupled to the separate respective paint cartridge 30 via the flexible tubing 104 to accommodate movement of the spray nozzles 312 relative to the respective paint cartridges 30.

Also shown are two filters 22a, 22b, which may be used to filter the relevant deposition material(s) to ensure particulates don't block the flexible tubing 104 and spray nozzles 312, if required in certain deposition situations and with certain materials.

The plurality of spray nozzles 312 is mounted to a lower plate 332 of a print head arrangement of FIG. 5a, 5c, 5b, which may be, in some embodiments, formed from a length of extruded rail with a plate through which the spray nozzles 312 project. The spray nozzles 312 are configured to spray paint onto the ground surface such that a desired marking, or a desired image, is printed onto the ground surface as the detachable deposition accessory 300 follows instructions to carry out a printing task which may be received from a user of the detachable deposition accessory 300.

A pump 29, such as a self-priming diaphragm pump 29, may be used to pressurise the airless spray system 20 for each respective spray nozzle 312. The pump 29 may be individually controlled by a controller (not shown) and the pressure for each pump 29 may be adjusted depending on the paint being used for the respective spray nozzle 312. Different paints may be of different viscosities, therefore requiring different pressure to be applied to the spray system for each spray nozzle 312. In operation, paint is ejected from the spray nozzles 312 under pressure, which may be up to a maximum of 10 bar (1000 kPa) hydraulic pressure per spray nozzle 312. In some embodiments the paint is ejected from the spray nozzles 312 at a pressure of 7 bar (700 kPa).

The spray system 20 may beneficially reduce or prevent dripping of paint from the spray nozzles 312, by providing back pressure at the spray nozzles 312. Such an arrangement differs from agricultural spray systems, which use less viscous fluids than the present invention and use breather nozzles to help with back pressure, which can lead to dripping of fluids onto the ground surface. However, in agricultural spray systems, dripping of the fluids onto the ground surface is generally not a problem. The higher viscosity fluids, such as paint, used in the present invention don't provide the same back pressure problem, and this coupled with the pressurization of the spray system minimises any dripping of paint onto the ground surface.

In some embodiments the flexible tubing 104 used to transfer or convey paint from a cartridge 30 to a spray nozzle 312 may have a small inner diameter, for example 2.5 mm diameter, with a relatively thin sidewall. Various materials may be used to form the flexible tubing 104 where some materials may be one of polyurethane, polyvinyl chloride, polypropylene, fluoropolymer, rubber, silicone or other similar materials.

The system controller (not shown) may be configured to control a valve 313, such as a solenoid valve, for each of the plurality of spray nozzles 312, dependent upon the position of the detachable deposition accessory 300 on the ground surface.

Also shown is an ID tag 14 and an ID reader 13. ID tag 14 may also comprise a barcode or other smart label, which is used for identification of the cartridges 30. The ID reader 13 is an Integral part of the chassis casing 12 and is for registering the presence of the cartridges 30 when firmly in place in the frame (not shown). The ID reader 13 may be a photodiode or a RFID tag that communicates with an ID tag 14 of the cartridge 30. ID tag 14 may also comprise a barcode or other smart label, which is used for identification of each cartridge 30.

The detachable deposition accessory 300, via the umbilical connected to an AMR (see FIG. 2a) can communicate with a remote server (not illustrated), through any wired or wireless network, via the navigation/communications module 122b. For example, the detachable deposition accessory 300 may communicate with a remote server via a cellular network. A user can initiate the printing of a print task, such as the printing of markings or printing of an image, by selecting a printing task on a connected user device which then provides instructions for the printer to follow in order to carry out the printing task.

The user may also register the marking material using the ID tag 14 to match marking materials held in a database by way of communication with the navigation and communication means 122b.

The database may contain a list of verified marking materials authorised for use and may in return grant permission for the detachable deposition accessory 300 to accept the material and may, depending in the type of material, make mechanical or software adjustments. For example, a print head 350 height may be adjusted to spray fertilizer in a different way to the height needed for high resolution image printing.

The ID reader 13 may also be used to register the presence of the cartridges 30 and further verify that the correct cartridge 30 is located in the correct frame and may further undertake a verified check of the authenticity of the cartridge 30 using RFID technology or other suitable sensor technologies. The database may comprise a revocation list of packaging or materials that are no longer supported, out of date or out of contract. In which case an error message may be displayed to the user.

FIGS. 9a, 9b, 9c, 9d and 9e are different views of the individual components of the coupling used between the AMR and the ground deposition accessory of FIGS. 1 to 5. As best shown in FIG. 9d, there is shown a tow arm 311 and a coupling arrangement 310 which comprises two support sections 70a & 70b-pivoted around single axis pivot point 71a to allow for any difference in height between underside of the AMR and the height of the detachable deposition accessory (not shown). The need and location of pivot 71a would be dependent on the required length of the support sections and the height difference—as should be understood by someone skilled in art.

The coupling arrangement 310 also a first metal plate 72a, mounted on the second support section 70b and connected to a first single axis pivot 71b to allow only a single plane of rotation/pivot of a second metal plate 72b, also connected to the second single axis pivot 71b.

The first and second single axis pivots 71a, b, restrict movement in yaw, but which allow for some minimal movement in pitch. This is necessary to keep the detachable deposition accessory 300 perpendicular to the AMR 200 for accurate deposition applications, though still allow for some minimal pitch movement of the detachable deposition accessory 300 when moving over uneven ground, for example.

The first metal plate 72a also further comprises one or more motion stops 73a & 73b, that also further limit the movement of the second metal plate 72b.

The individual components of the single axis pivots 71a, 71b are best shown in FIG. 9e. There is shown two metal plates, 40a, 40b, a washer 40c and an axis pin 40d. It should be clear to someone skilled in the art that other single axis pivot mechanisms could be used. The coupling arrangement also comprises a retaining locator seat 76 (as best shown in FIG. 9d), located on the rear underside of the AMR 200 to ensure proper seating and alignment, prior to activation of the electromagnet circuit. The retaining locator seat 75 comprises a second metal plate 77 which can be magnetised to a 0.5 tonne pull force and a retainer locator panel 76 which allows the mounting plate 72b of the detachable deposition accessory 300 to sit in the retaining locator seat 75 at a distance within a 5 mm distance differential, as such when the electromagnetic metal plate 77 is switched on, it pulls the mounting plate 72b of the detachable print head accessory 100 into a tight coupling. The magnetic connection 311 being powerful enough and strong enough to keep the detachable deposition accessory 300 attached securely enough to minimise any lateral or vibrational movement between the detachable deposition accessory 300 and the AMR 200.

As such the dedicated retaining locator seat 75 provides high accuracy and repeatability in alignment—ensuring such before the electromagnetic is turned on. If the coupling 311 is not sat in a repeatable and systematic location each time, the true centre of the detachable deposition accessory 300 cannot be ensured for printing and tiling functions, as such any navigation and positional calculations made by the AMR 200 may lead to misalignment of any print and/or deposition made by the detachable deposition accessory 300.

Whilst someone skilled in the art would understand that trailers are usually allowed to pivot around a connecting point to assist turning when the main vehicle turns. However, this turning is undesired in a print or accurate deposition situation, as there is a need to ensure the detachable deposition accessory 300 remains perfectly perpendicular, at least within a 5 degree axis of movement in the yaw, to the locomotion drive centre of the AMR 200, such that it can be assured that the detachable deposition accessory 300 is able to print perpendicular to the direction of travel of the AMR 200. Thus, the only pivot allowable is one that allows a controlled radial movement about the magnetic plate in the pitch axis.

In other embodiments (not shown), alignment sensors are used to aid with seating alignment reinforcement or other functions such as fail-safe sensors should the electromagnetic coupling fail, in order to trigger full power off. A mechanical connecting ‘chain’ may also be used in case the maglock fails for any unexpected condition (power failure etc). This would avoid the situation where the trailer may detach and therefore the data and power lines would be vulnerable to break, since they would remain connected otherwise.

In another embodiment (not shown), the coupling could be formed of a fully mechanical clamping means, and in which case, the connecting coupling need not be made totally of metal, provided that movement in the yaw axis is restricted.

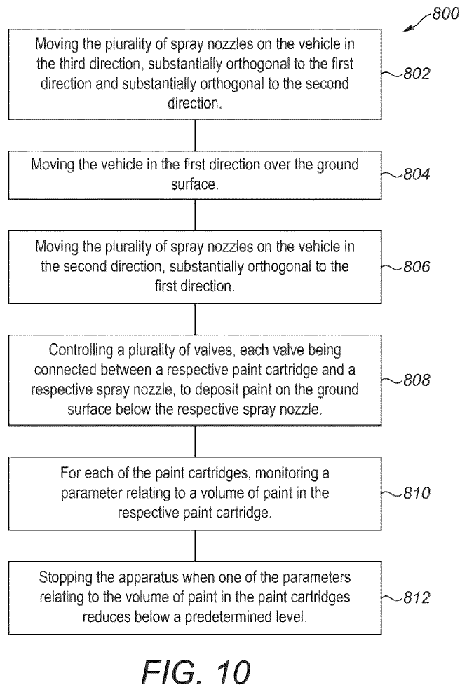

FIG. 10 illustrates a flow diagram of a method 800 of marking a ground surface, the method 800 comprising block 804 where, in use, the detachable deposition accessory 300 is moved in a first direction over the ground surface, and block 806 where, in use, a plurality of spray nozzles 312 on the detachable deposition accessory 300 are moved in a second direction, substantially orthogonal to the first direction. In particular, the method 800 of marking a ground surface can be carried out using the detachable deposition accessory 300 as previously described.

In an initialization phase for the detachable deposition accessory 300, a number of actions can be carried out to initialize the detachable deposition accessory 300 for printing an image on a ground surface, these actions being dependent on the current status of the detachable deposition accessory 300. In particular, a print task can be provided to the detachable deposition accessory 300, by the provision of instructions from a remote server being sent to the ground printer via controller 112b on the detachable deposition accessory 300, those instructions being enacted by an application processor (not shown) connected to the controller 122b.

At block 802 the method 800 may comprise: moving the plurality of spray nozzles 312 on the detachable deposition accessory 300 in the third direction, substantially orthogonal to the first direction and substantially orthogonal to the second direction. Such movement of the plurality of spray nozzles 312 may be required in order to provide an appropriate pixel size for the image printing or to account for the type of surface forming the ground surface.

At block 808, the method 800 may comprise: controlling a plurality of valves (not shown), each valve (not shown) being connected between a respective paint cartridge 30 and a respective spray nozzle 312, to deposit paint on the ground surface below the respective spray nozzle 312.

At block 810, the method 800 may comprise: for each of the paint cartridges 30, monitoring a parameter relating to a volume of paint in the respective paint cartridge 30.

At block 812, the method 800 may comprise stopping the detachable deposition accessory 300 when one of the parameters relating to the volume of paint in the paint cartridges 30 reduces below a predetermined level. By stopping the detachable deposition accessory 300, the replacement or refilling of the paint cartridge 30 is possible, which helps to avoid errors in printing an image through missing areas when paint runs out in a paint cartridge 30. In one embodiment, the detachable deposition accessory 300 may comprise a sensor system (not shown) which is in communication with the system controller 112b and allows monitoring of the volume of paint in the paint cartridge 30.

Although embodiments of the present invention have been described in the preceding paragraphs with reference to various examples, it should be appreciated that modifications to the examples given can be made without departing from the scope of the invention as claimed.

The detachable deposition accessory 300 and methods 800 described herein can be adapted for use with different types of ground surfaces. The detachable deposition accessory 300 and methods 800 described herein can be used to deposit paint on multiple different substrates, surfaces, or the ground. For example, these could be, grass, turf, AstroTurf, artificial turf, synthetic turf, plastic turf, concrete, polished concrete, tarmac or tarmacadam ground surfaces, dirt, gravel, wood chip, carpeting, rubber, roads, asphalt, brick, sand, beaches, mud, clay wood, decking, tiling, stone, rock and rock formations of varying types of rock or stone, snow, ice, ice rinks, artificial snow, polymer surfaces such as polyurethane, plastic, glass and leather.

The detachable deposition accessory 300 and methods 800 described herein can be adapted for use with different surfaces, such as sports (e.g., football, cricket, racing, rugby, hockey, ice hockey, skiing, shooting) pitches, ski slopes, dry ski slopes, racecourses, gymnasiums, indoor sports venues and running tracks.

In some embodiments, the detachable deposition accessory 300 and methods 800 described herein may be used for printing or painting on a substrate or on the ground surface. This can be to print or paint, with inks or paint, logos, information, advertising, or messages on the ground surface. When large images are printed, they are printed with adjacent dots or pixels so that when viewed from above or a suitable distance from afar (e.g. from the stand in a stadium or from a television view) the images are easily determined. Print instructions can be determined so that when an image, e.g., a logo is printed, it can be visible from a stadium stand or by a viewer watching an event at home on television. The detachable deposition accessory 300 and methods 800 described herein offer an improvement to printing methods for advertising purposes. Brand logos, slogans, pictures etc. can be printed to advertise a brand, logo or message. These can be printed more efficiently, quickly and with a higher degree of accuracy than the methods and printers of the prior art.

The detachable deposition accessory 300 is therefore in some embodiments configured to print an image or logo on a ground surface, the ground printer housing a plurality of print cartridges containing a material for deposition, the material for deposition contained within each print cartridge being an ink or paint selected from a cyan, magenta, yellow, black, white, green, blue, or red, colour, the image or logo optionally being an advertising logo, design or safety warning. In various embodiments, the material for deposition is a marking material such as a paint, ink, coloured material, or powder.

In some further embodiments, there is provided a detachable deposition accessory for depositing a material on a ground surface, the wherein the detachable deposition accessory is operable to move in a first direction, the detachable deposition accessory comprising: locomotion means, the locomotion means mounted on a chassis; a deposition arrangement comprising one or more spray nozzles; a coupling capable of attaching the detachable deposition accessory to an autonomous mobile robot (AMR); and a deposition material cartridge mount, wherein the deposition material cartridge mount is operable to receive a removable paint cartridge at a first end and is fluidly coupled to the deposition arrangement at a second end.

Preferably, wherein the detachable deposition accessory further comprises: a horizontal mounting rail arranged in a second direction, substantially orthogonal to the first direction; wherein the deposition arrangement is movably connected to the horizontal mounting rail and arranged in a third direction, substantially orthogonal to the first direction and substantially orthogonal to the second direction; and wherein the plurality of spray nozzles is aligned in a horizontal axis in the first direction.

Further preferably wherein the deposition arrangement is configured to move along the horizontal mounting rail between a first end stop at a first end of the horizontal mounting rail and a second end stop at a second end of the horizontal mounting rail opposed to the first end of the horizontal mounting rail.

Preferably, wherein one, or both, of the first end stop and the second end stop comprises a sensor to detect the position of the deposition arrangement.

Further preferably, wherein the deposition arrangement is operable to move orthogonally to the horizontal mounting rail in the third direction by attachment to a vertical mounting rail.

Preferably, wherein each spray nozzle of the plurality of spray nozzles is coupled to a separate respective deposition material cartridge mount.

Further preferably, wherein each spray nozzle of the one or more spray nozzles is fluidly coupled to a separate respective deposition material cartridge mount via a spray assembly.

Also, preferably wherein each spray nozzle is coupled to the separate respective deposition material cartridge mount via flexible tubing to accommodate movement of the spray nozzles relative to the respective deposition material cartridges.

Preferably, wherein the flexible tubing is retained in a cable carrier, the flexible tubing passing from a respective spray nozzle, through the cable carrier, to the respective deposition material cartridge.

Further preferably, wherein the deposition arrangement further comprises a first motor, and a pulley and a tension belt, wherein the first motor which drives a pulley, which in turn drives a tension belt and which are operable to move the deposition arrangement along the horizontal rail.

Preferably, wherein the tension belt, is held in place by two guide wheels and is fixed in place at each end of the horizontal rail by fixings.

Also preferably, wherein the deposition arrangement further comprises a second motor, and a lead screw, wherein the second motor drives the lead screw to move the deposition arrangement along the vertical rail.

Further preferably, wherein the print nozzles are arranged symmetrically around the position of the vertical rail.

Preferably, wherein the deposition material cartridge mount further comprises a flexible guide, wherein the flexible guide is operable to guide a deposition material cartridge into the quick-connect connector.

Also preferably, wherein the flexible guide further comprises a retaining means located at an end furthest away from the chassis mount, wherein the retaining means is operable to retain a deposition material cartridge in place.

Further preferably, wherein the deposition material cartridge mount further comprises a quick-connect connector.

Also preferably, wherein the spray assembly further comprises a pump and a valve.

Preferably, further comprising a controller configured to control the operation of the plurality of spray nozzles to mark the ground surface.

Also preferably, wherein paint is ejected from each spray nozzle under pressure to form small droplets of paint to uniformly cover the ground surface.

Preferably, wherein the coupling further comprises a data connection, wherein the data connection is operable to send data between the detachable deposition accessory and the autonomous deposition apparatus.

Further preferably, wherein the coupling further comprises a power connection, wherein the power connection is operable to send electrical power between the detachable deposition accessory and the autonomous deposition apparatus.

Also preferably, wherein the control unit operable to send data from the detachable deposition accessory to an AMR.

Preferably, wherein the coupling further comprises magnetic attachment means.

Further preferably, wherein the detachable deposition accessory further comprises two stabilising arms.

In a second aspect of the present invention, there is provided a removable deposition cartridge suitable for use with the detachable deposition accessory according to the first aspect.

Preferably, wherein the material for deposition is a herbicide, pesticide, insecticide, plant growth aid, water or marking material, optionally wherein the marking material is a paint, ink, coloured material, powder.

Thus, the specific arrangement of the of the spray head arrangement, horizontal rail and tubing carrier provides advantage over the systems and methods known art, as they can be adjusted to fit any width deposition apparatus by the simple adjustment of the horizontal rail, tubing carrier and as such, flexible tubing.

Advantageously, the combination of a retaining holders for retaining deposition material tanks in situ in a frame, or chassis, along with the hose connection mechanism itself, reduces weight and leads to a more compact design. Thus, this means there is no need for a tank frame within the chassis frame itself, reducing weight and again leading to a compaction of design. More user friendly, easier to see paint usage amounts.

Thus advantageously, there is provided the means to quickly and easily change the abilities of the autonomous deposition machine for multiple different deposition application situations.

Further, preferably wherein the deposition instructions are a command to print an image in a certain size and the control unit calculates the required sections of the print and/or wherein the user sends deposition instructions to the autonomous deposition apparatus via a cloud server or device, or an edge server or device.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the Invention believed to be of particular importance, it should be understood that the Applicant claims protection in respect of any patentable feature or combination of features hereinbefore referred to and/or shown in the drawings whether or not particular emphasis has been placed thereon.

1. A coupling arrangement for a coupling a detachable deposition accessory to an autonomous mobile robot (AMR), the coupling arrangement comprising:
a first portion, the first portion is configured to be removably coupled to the AMR, and is operable to be pivotable about the pitch axis only;
a second portion, the second portion is fixedly attached to the AMR and is configured to retain the first portion and limit movement of the detachable deposition accessory in the yaw axis, when coupled to the AMR; and
a support arm, wherein the support arm extends between the first and second portions.

2. A coupling arrangement as claimed in claim 1, wherein movement in the yaw axis is limited to less than a 5-degree angle between the first and second portions.

3. A coupling arrangement as claimed in claim 1, wherein either the first and/or second portions are comprised of metal plates.

4. A coupling arrangement as claimed in claim 3, wherein the first and second portions are operable to be magnetised by an applied current.

5. A coupling arrangement as claimed in claim 1, wherein the second portion further comprises a mechanical clamp arrangement, and wherein the mechanical clamp arrangement is configured to retain the first portion and limit movement of the autonomous deposition accessory in the yaw axis, when coupled to the detachable deposition accessory.

6. A coupling arrangement as claimed in claim 1, wherein the second portion further comprises a retaining seat, operable to retain the first portion in a planar alignment with the second portion.

7. A coupling arrangement as claimed in claim 1, wherein the support arm maybe pivotable about a second single pivot axis, also limited in the yaw axis.

8. A coupling arrangement as claimed in claim 1, wherein the support arm may be formed of metal.

9. A coupling arrangement as claimed in claim 1, wherein either of the first or second portions further comprise movement stoppers, operable to limit the movement of the either of the first or second portions in the pitch axis.

10. A coupling arrangement according to claim 1, wherein the coupling further comprises a data connection, wherein the data connection is operable to send data between the detachable deposition accessory and the AMR.

11. A coupling arrangement according to claim 1, wherein the coupling further comprises a power connection, wherein the power connection is operable to send electrical power between the detachable deposition accessory and the autonomous deposition apparatus.

12. A detachable deposition accessory for coupling to an autonomous mobile robot (AMR), the detachable deposition accessory comprising:
a locomotion arrangement;
a deposition arrangement;
at least one receptacle to hold a deposition material;
a control unit, the control unit operable to receive at least one deposition instruction from the AMR; and
the coupling arrangement according to claim 1.

13. A detachable deposition accessory according to claim 12, wherein the control unit operable to send data from the detachable deposition accessory to the AMR.

14. A detachable deposition accessory according to claim 12, wherein the detachable deposition accessory further comprises a chassis with a nozzle array on a traverse guide.

15. An autonomous mobile robot (AMR), the AMR comprising:
a locomotion arrangement;
a control unit, the control unit operable to receive at least one deposition instruction; and
a coupling arrangement capable of attaching to the detachable deposition accessory according to claim 12.

16. A method of coupling a detachable deposition accessory to the autonomous mobile robot (AMR) of claim 15, the method comprising:
moving the detachable deposition accessory and the AMR into close proximity;
locating a first portion of the coupling arrangement attached to the detachable deposition accessory into a housing seat located on the AMR; and
switching on the electromagnet system.

17. The method of claim 16, further comprising the step of coupling a data and/or power cable between the detachable deposition accessory and the AMR.

18. The method of claim 16, further comprising the step of attaching a break chain between the detachable deposition accessory and the AMR.

19. The method of claim 16, wherein the moving step further comprises using position sensors located on either of the detachable deposition accessory or the AMR.

20. A method of depositing a material using the AMR of claim 16, the method comprising:
an operator coupling the detachable deposition accessory to an AMR;
receiving at least one deposition instruction from a user;
the AMR controlling the detachable deposition accessory to deposit material according to the deposition instructions.

21. A method as claimed in claim 20, wherein after it is coupled to the AMR, the detachable deposition accessory sends data to the AMR.

22. A method as claimed in claim 20, wherein the user sends deposition instructions to the AMR via a cloud server or device, or an edge server or device.

23. An apparatus or method as claimed in claim 1, wherein the material for deposition is a herbicide, pesticide, insecticide, plant growth aid, water or marking material, optionally wherein the marking material is a paint, ink, coloured material, powder.
